(19) United States
(12) Patent Application Publication
(10) Pub. No.: US 2003/0047935 A1
(43) Pub. Date: Mar. 13, 2003

(54) Cover with elastic fastener for gathered book-like bound sheets

(75) Inventor: Giancarlo Romiti, Firenze (IT)

Correspondence Address: John S. Egbert, Harrison & Egbert, 7th Floor, 412 Main Street, Houston, TX, 77002, US

(73) Assignee: DIARPELL S.R.L., Firenze (IT)

(21) Appl. No.: 10/242,278

(22) Filed: Sep. 12, 2002

(30) Foreign Application Priority Data
Sep. 13, 2001 (IT) FI/2001/U/000078

(51) Int. Cl. B42D 3/00

(52) U.S. Cl. 281/35

(57) ABSTRACT

A cover for gathered book-like bound sheets is constituted by a front board and a rear board jointed by one side to a spine, such as a book, an agenda, an address-book, wherein an elastic means encircling said cover from the spine towards the front edge of the gathered book-like bound sheets constitutes a transversal retaining ring to prevent the accidental opening of the bound volume.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a special modified cover, external to book-like bound sheets.

### BACKGROUND OF THE INVENTION

It is well-known the problem to steadily hold, at the side opposite to the binding spine, a number of book-like bound sheets provided with a cover.

This is even more evident considering that the gathered sheets can constitute a book, an agenda, a small phone-book, a small note book, where there is a triple requirement: to hold the gathered sheets closed for privacy reasons, to maintain them laterally inaccessible at the side opposite to the binding spine and, last, to contain movable additional sheets like memo or similar interposed among the single gathered sheets.

The above mentioned user's needs are usually satisfied by providing the cover, on its larger free sides, with a tab having a press button which holds together the top cover face with the lower one, or in some more rough cases, with a tab which holds together a face with the other one through a loop placed on the face opposite to that where said tab originates.

In some other more usual cases, such as for agendas, to hold the gathered book-like bound sheets closed, the cover itself is jointed to a counter-cover provided with a zip through which it can be closed and therefore achieving the above-mentioned aims of privacy and containment.

### BRIEF SUMMARY OF THE INVENTION

The aim of the present invention is to obtain a cover which holds the bound sheets gathered inside and connected to its spine in a position usually known as “closed-book”.

Another aim is to achieve the above without modify the constructive and morphological features of usual gathered book-like bound sheets.

Still another aim, not less important than others, is to obtain a modified cover according to the invention, through a manufacturing process suitable with usual industrial manufacture and without using special machines or skilled labor.

These and other aims and advantages will better arise in a preferred but not exclusive embodiment wherein a cover for gathered book-like bound sheets is constituted by a front board and a rear board which are connected by one side to a spine, such as in a book, an agenda, an address-book, where an elastic means encircling said cover from the spine towards the front edge of the gathered sheets constitutes a transversal retaining ring to prevent the accidental opening of the bound volume.

### BRIEF DESCRIPTION OF THE SEVERAL VIEWS OF THE DRAWINGS

All the above is illustrated, as indicative, in the enclosed drawings.

FIG. 1 shows a sectional view of a modified cover with the gathered book-like bound sheets in a position known as “open”.

FIG. 2 shows a sectional view of a modified cover with the gathered book-like bound sheets in a position known as “closed” by using this invention.

FIG. 3 shows a top view of a modified cover with the gathered book-like bound sheets in a position known as “closed” vertically placed.

### DETAILED DESCRIPTION OF THE INVENTION

The attached figures show a set of gathered book-like bound sheets 10, provided with a cover having a front board 1, a rear board.2 and a spine 3; the gathered bound sheets 10 are jointed at the points 11 and 12 of the binding side 5 to the spine 3 to leave an hollow space 4 between said binding and said spine.

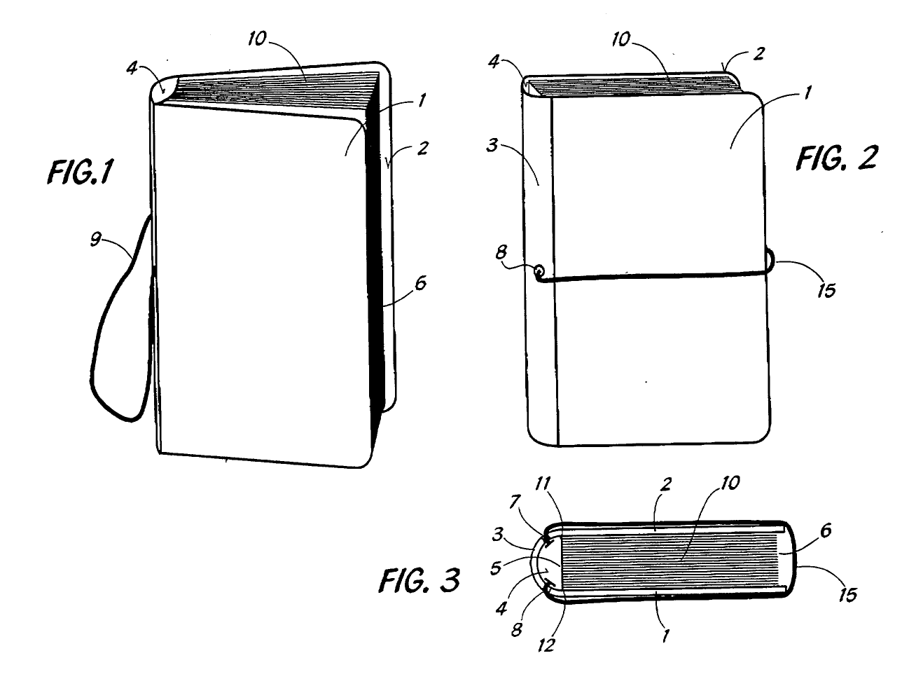

With the cover open and without applying the invention, the gathered sheets are free to move and confound at the terminal part 6 opposite to the binding side, when the gathered book-like sheets are in the position known as “open”, see FIG. 1.

On the spine 3, in the area constituting the hollow space 4, in central position on its two opposite sides and adjacent respectively to the two cover boards, the front board 1 and the rear board 2, two passing holes 7 and 8 are provided, each of them suitable to house a terminal part of an elastic or of an elastic tape 9, constituting a ring 15, which is external to the two cover boards.

It is clear how said ring 15, in its rest position, is free along the cover spine, as illustrated in FIG. 1, whereas as shown in FIG. 2, to perform its aim of closing the cover, it will be transversely passed around the cover and consequently, as it will retain inside both said cover and the bound sheets, it will contain and orderly hold said whole set maintaining said sheets protected.

The position of the housing holes of the terminal parts of the elastic, which are on the cover spine, so that the terminal parts of the elastic ring are inside the hollow space, has the specific aim to assemble the cover in a separate phase from the book-like bound sheets which are independently gathered; consequently the insertion of said book-like bound sheets inside the cover can be made at any time, then the final binding of the manufactured article will be simply accomplished.

Several different embodiments of this invention can be provided, however without departing from the present inventive scope, for example the positioning of the holes housing the terminal part of the elastic ring can be modified as they can be placed in any area of the spine or of the cover faces, or said holes may be passing or not passing, in said embodiment the housing of the terminal parts of the elastic ring will be “drowned” inside the thickness of the cover or even projecting out from the thickness of the said cover.

I claim:

1. Cover with elastic fastener for gathered book-like bound sheets constituted by a front board and a rear board said boards connected by one side to a spine to contain said gathered book like bound sheets such as a book, an agenda., an address-book, said gathered sheets steadily jointed inside said cover wherein said cover has an elastic means which encircling said cover from the spine towards the front edge of the gathered sheets constitutes a transversal retaining ring to prevent the accidental opening of the bound volume.

2. Cover with elastic fastener for gathered book-like bound sheets according to claim 1, wherein the gathered book-like bound sheets jointed to the spine by the binding side constitute an hollow space.

3. Cover with elastic fastener for gathered book-like bound sheets according to claim 2, wherein said cover has on the spine, in central position on its two opposite sides and adjacent to the two cover boards, two passing or not passing holes housing the terminal parts of an elastic or of an elastic tape constituting the external transversal retaining ring.

4. Cover with elastic fastener for gathered book-like bound sheets according to claim 1, wherein the holes fit for housing the terminal parts of the retaining elastic means are placed in any area of the spine and/or of the front or rear cover boards.

5. Cover with elastic fastener for gathered book-like bound sheets according to claim 1, wherein the terminal parts of the elastic means constituting the retaining ring start directly from the spine or from the cover boards, drowned into its thickness.

6. Cover with elastic fastener for gathered book-like bound sheets according to claim 5, wherein the terminal parts of the elastic means constituting the retaining ring start directly from the spine and inside the hollow space.
